(19) United States
(12) Patent Application Publication
(10) Pub. No.: US 2023/0385252 A1
(43) Pub. Date: Nov. 30, 2023

(54) DATA QUALITY ANALYZE EXECUTION IN DATA GOVERNANCE

(71) Applicant: International Business Machines Corporation, Armonk, NY (US)

(72) Inventors: Xu Bin Cai, BEIJING (CN); Wei Wang, BEIJING (CN); Chun Hua Sun, BEIJING (CN); Chun Leng, BEIJING (CN); Pin Lv, BEIJING (CN); Yi Yang Ren, BEIJING (CN); Jian Ling Shi, Baoji (CN); YI WANG, BEIJING (CN); Tao Zhuang, BEIJING (CN)

(21) Appl. No.: 17/824,200

(22) Filed: May 25, 2022

(51) Int. Cl. G06F 16/215; G06F 16/23; G06F 16/242

(52) U.S. Cl. CPC G06F 16/215; G06F 16/2365; G06F 16/2448

(57) ABSTRACT

An approach is provided that retrieves fingerprint configuration sets corresponding to a received data source and uses the configuration sets to generate fingerprints that correspond to the data source. These fingerprints are compared to a number of fingerprints that are stored in a repository. If a match is found, then the data quality configuration set is retrieved from the repository and used to perform a data quality analysis. On the other hand, if a match is not found, then one of the configuration sets is selected to perform the data quality analysis on the received data source and the repository is updated so that the selected fingerprint configuration set corresponds to the received data source.

### BACKGROUND

Investigating data aids in understanding the quality of a data source and clarifies the direction of succeeding phases of workflow. In addition, the investigation indicates the degree of processing needed to create the target re-engineered data. Investigating data identifies errors and validates the contents of fields in a data file. This lets the organization identify and correct data problems before they corrupt new systems.

### SUMMARY

An approach is provided that builds fingerprints of data sources using configuration sets. The fingerprints are used to more quickly investigate data sources to identify errors and validate content without using more exhaustive methods that create system bottlenecks. An approach is provided that retrieves fingerprint configuration sets corresponding to a received data source and uses the configuration sets to generate fingerprints that correspond to the data source. These fingerprints are compared to a number of fingerprints that are stored in a repository. If a match is found, then the data quality configuration set is retrieved from the repository and used to perform a data quality analysis. On the other hand, if a match is not found, then one of the configuration sets is selected to perform the data quality analysis on the received data source and the repository is updated so that the selected fingerprint configuration set corresponds to the received data source.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention will be apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings, wherein:

FIG. 1 depicts a network environment that includes a knowledge manager that utilizes a knowledge base;

FIG. 2 is a block diagram of a processor and components of an information handling system such as those shown in FIG. 1;

FIG. 3A is a chart depicting an example using the DQA method showing where a bottleneck occurs;

FIG. 3B is a chart depicting example configuration sets (ConfSet) used during fingerprint matching;

FIG. 4 is a flowchart depicting steps taken during a data quality analysis process using fingerprint matching;

FIG. 5A is a chart depicting various dimensions and attributes to calculate fingerprints using a ConfSet;

FIG. 5B is a chart depicting sample data for the various dimensions and attributes to calculate fingerprints using a ConfSet;

FIG. 5C is a chart depicting matching a source fingerprint with various target fingerprints;

FIG. 6 is a flowchart showing a process that matches fingerprints using various attributes of an input data source (table); and

FIG. 7 is a flowchart of an auto build process that is based on generation and matching of fingerprints.

### DETAILED DESCRIPTION

The Figures describe an approach to build fingerprints of data sources using configuration sets. The fingerprints are used to more quickly investigate data sources to identify errors and validate content without using more exhaustive methods that create system bottlenecks. The investigation phase parses and analyzes free-form and single-domain columns by determining the number and frequency of unique values, and classifying or assigning a business meaning to each occurrence of a value within a column. In one embodiment, the Investigate stage performs the following tasks: (1) Uncovers trends, potential anomalies, metadata discrepancies, and undocumented business practices; (2) Identifies problem areas; (3) Proves or disproves assumptions made about the data; and (4) Verifies the reliability of columns proposed as matching criteria. After the Investigate stage completes, the results are evaluated to help in planning the rest of the workflow.

In data governance area, data quality is an important index to mark if the data is good enough for following usage, such as Data Science Application. In data governance domain, IBM's product, “CP4D WKC”, provides features “CA—Column Analyze”+“DQA—Data Quality Analyze”, which can automatically analyze data column and data quality for unknown data of DBMS, and provide index based on analytics result. While IBM's CA+DQA analyzes data sources for quality issues, it takes a long time when analyzes big data volume and it has big performance issue and sometime critical issue, such as OOM, over CPU limit, will break the job running. In order to complete such kind of CA+DQA job, it need to tuning system and rerun the job several times. It wastes resource and breaks production system schedule.

The approach described herein provides many advantages. This disclosure can quickly find appropriate ConfSet for the input data columns This disclosure effectively improves DQA execution performance in data governance products, especially when analyze a large number of datasets Self Feedback, Self Improved ConfSet System by auto build new fingerprint which are not exist in the ConfSet system, and then improves the system by learning the new fingerprint.

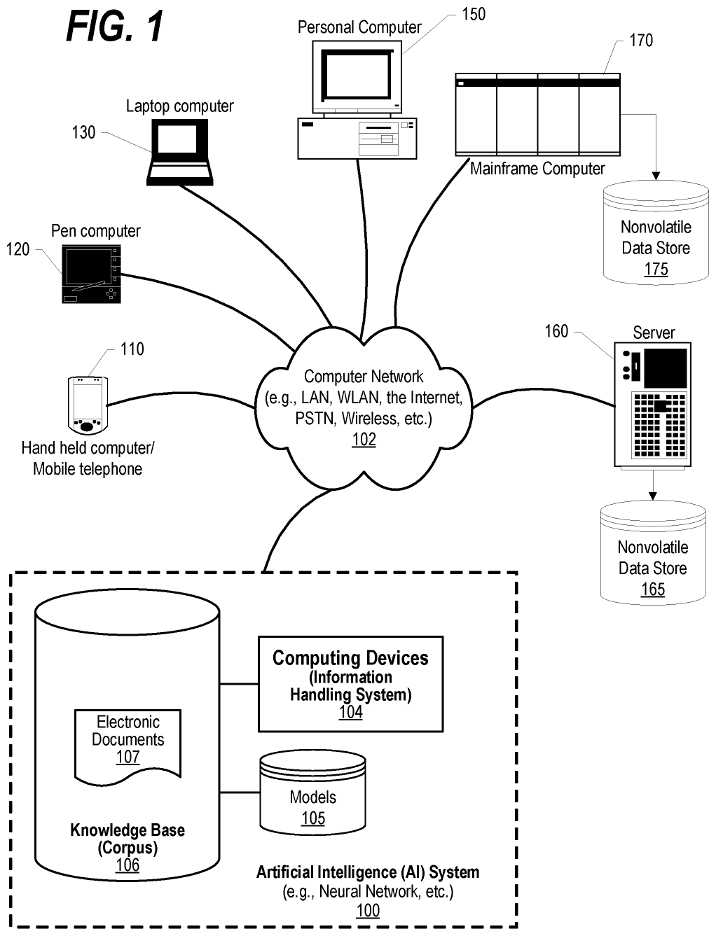

FIG. 1 depicts a schematic diagram of one illustrative embodiment of artificial intelligence (AI) system 100 in a computer network 102. AI system 100 includes artificial intelligence computing device 104 (comprising one or more processors and one or more memories, and potentially any other computing device elements generally known in the art including buses, storage devices, communication interfaces, and the like) that connects AI system 100 to the computer network 102. The network 102 may include multiple computing devices 104 in communication with each other and with other devices or components via one or more wired and/or wireless data communication links, where each communication link may comprise one or more of wires, routers, switches, transmitters, receivers, or the like. AI system 100 and network 102 may enable functionality, such as question/answer (QA) generation functionality, for one or more content users. Other embodiments of AI system 100 may be used with components, systems, sub-systems, and/or devices other than those that are depicted herein.

AI system 100 maintains knowledge base 106, also known as a “corpus,” which is a store of information or data that the AI system draws on to solve problems. This knowledge base includes underlying sets of facts, assumptions, models, and rules which the AI system has available in order to solve problems.

AI system 100 may be configured to receive inputs from various sources. For example, AI system 100 may receive input from the network 102, a corpus of electronic documents 107 or other data, a content creator, content users, and other possible sources of input. In one embodiment, some or all of the inputs to AI system 100 may be routed through the network 102. The various computing devices on the network 102 may include access points for content creators and content users. Some of the computing devices may include devices for a database storing the corpus of data. The network 102 may include local network connections and remote connections in various embodiments, such that artificial intelligence 100 may operate in environments of any size, including local and global, e.g., the Internet. Additionally, artificial intelligence 100 serves as a front-end system that can make available a variety of knowledge extracted from or represented in documents, network-accessible sources and/or structured data sources. In this manner, some processes populate the artificial intelligence with the artificial intelligence also including input interfaces to receive knowledge requests and respond accordingly.

In one embodiment, the content creator creates content in electronic documents 107 for use as part of a corpus of data with AI system 100. Electronic documents 107 may include any file, text, article, or source of data for use in AI system 100. Content users may access AI system 100 via a network connection or an Internet connection to the network 102, and, in one embodiment, may input questions to AI system 100 that may be answered by the content in the corpus of data. As further described below, when a process evaluates a given section of a document for semantic content, the process can use a variety of conventions to query it from the artificial intelligence.

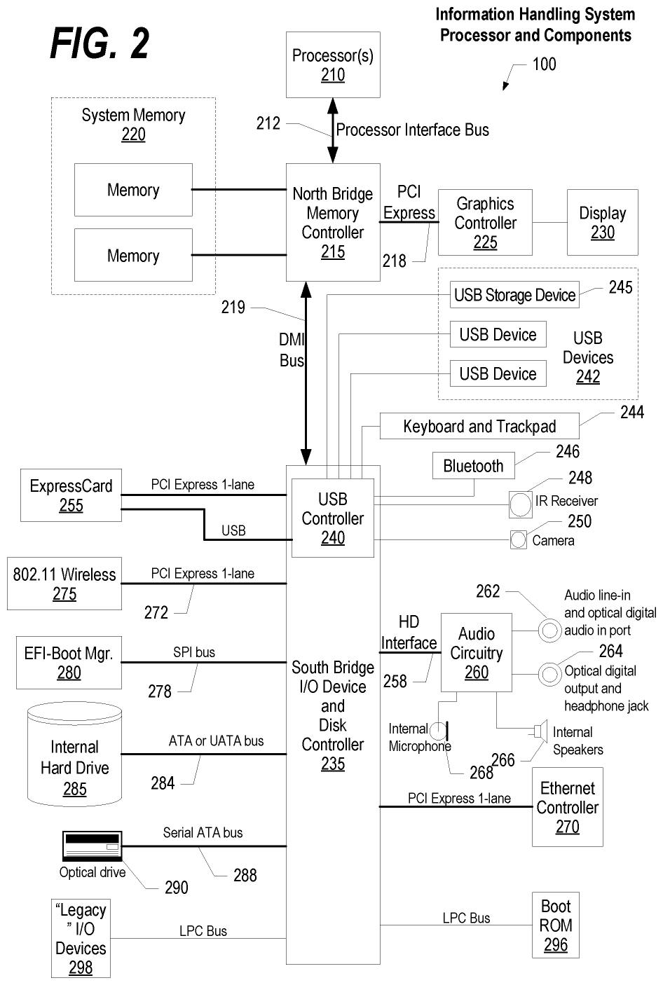

Types of information handling systems that can utilize AI system 100 range from small handheld devices, such as handheld computer/mobile telephone 110 to large mainframe systems, such as mainframe computer 170. Examples of handheld computer 110 include personal digital assistants (PDAs), personal entertainment devices, such as MP3 players, portable televisions, and compact disc players. Other examples of information handling systems include pen, or tablet, computer 120, laptop, or notebook, computer 130, personal computer system 150, and server 160. As shown, the various information handling systems can be networked together using computer network 102. Types of computer network 102 that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. Some of the information handling systems shown in FIG. 1 depicts separate nonvolatile data stores (server 160 utilizes nonvolatile data store 165, and mainframe computer 170 utilizes nonvolatile data store 175. The nonvolatile data store can be a component that is external to the various information handling systems or can be internal to one of the information handling systems. An illustrative example of an information handling system showing an exemplary processor and various components commonly accessed by the processor is shown in FIG. 2.

FIG. 2 illustrates information handling system 200, more particularly, a processor and common components, which is a simplified example of a computer system capable of performing the computing operations described herein. Information handling system 200 includes one or more processors 210 coupled to processor interface bus 212. Processor interface bus 212 connects processors 210 to Northbridge 215, which is also known as the Memory Controller Hub (MCH). Northbridge 215 connects to system memory 220 and provides a means for processor(s) 210 to access the system memory. Graphics controller 225 also connects to Northbridge 215. In one embodiment, PCI Express bus 218 connects Northbridge 215 to graphics controller 225. Graphics controller 225 connects to display device 230, such as a computer monitor.

Northbridge 215 and Southbridge 235 connect to each other using bus 219. In one embodiment, the bus is a Direct Media Interface (DMI) bus that transfers data at high speeds in each direction between Northbridge 215 and Southbridge 235. In another embodiment, a Peripheral Component Interconnect (PCI) bus connects the Northbridge and the Southbridge. Southbridge 235, also known as the I/O Controller Hub (ICH) is a chip that generally implements capabilities that operate at slower speeds than the capabilities provided by the Northbridge. Southbridge 235 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 296 and “legacy” I/O devices (using a “super I/O” chip). The “legacy” I/O devices (298) can include, for example, serial and parallel ports, keyboard, mouse, and/or a floppy disk controller. The LPC bus also connects Southbridge 235 to Trusted Platform Module (TPM) 295. Other components often included in Southbridge 235 include a Direct Memory Access (DMA) controller, a Programmable Interrupt Controller (PIC), and a storage device controller, which connects Southbridge 235 to nonvolatile storage device 285, such as a hard disk drive, using bus 284.

ExpressCard 255 is a slot that connects hot-pluggable devices to the information handling system. ExpressCard 255 supports both PCI Express and USB connectivity as it connects to Southbridge 235 using both the Universal Serial Bus (USB) the PCI Express bus. Southbridge 235 includes USB Controller 240 that provides USB connectivity to devices that connect to the USB. These devices include webcam (camera) 250, infrared (IR) receiver 248, keyboard and trackpad 244, and Bluetooth device 246, which provides for wireless personal area networks (PANs). USB Controller 240 also provides USB connectivity to other miscellaneous USB connected devices 242, such as a mouse, removable nonvolatile storage device 245, modems, network cards, ISDN connectors, fax, printers, USB hubs, and many other types of USB connected devices. While removable nonvolatile storage device 245 is shown as a USB-connected device, removable nonvolatile storage device 245 could be connected using a different interface, such as a Firewire interface, etcetera.

Wireless Local Area Network (LAN) device 275 connects to Southbridge 235 via the PCI or PCI Express bus 272. LAN device 275 typically implements one of the IEEE.802.11 standards of over-the-air modulation techniques that all use the same protocol to wireless communicate between information handling system 200 and another computer system or device. Optical storage device 290 connects to Southbridge 235 using Serial ATA (SATA) bus 288. Serial ATA adapters and devices communicate over a high-speed serial link. The Serial ATA bus also connects Southbridge 235 to other forms of storage devices, such as hard disk drives. Audio circuitry 260, such as a sound card, connects to Southbridge 235 via bus 258. Audio circuitry 260 also provides functionality such as audio line-in and optical digital audio in port 262, optical digital output and headphone jack 264, internal speakers 266, and internal microphone 268. Ethernet controller 270 connects to Southbridge 235 using a bus, such as the PCI or PCI Express bus. Ethernet controller 270 connects information handling system 200 to a computer network, such as a Local Area Network (LAN), the Internet, and other public and private computer networks.

While FIG. 2 shows one information handling system, an information handling system may take many forms, some of which are shown in FIG. 1. For example, an information handling system may take the form of a desktop, server, portable, laptop, notebook, or other form factor computer or data processing system. In addition, an information handling system may take other form factors such as a personal digital assistant (PDA), a gaming device, ATM machine, a portable telephone device, a communication device or other devices that include a processor and memory.

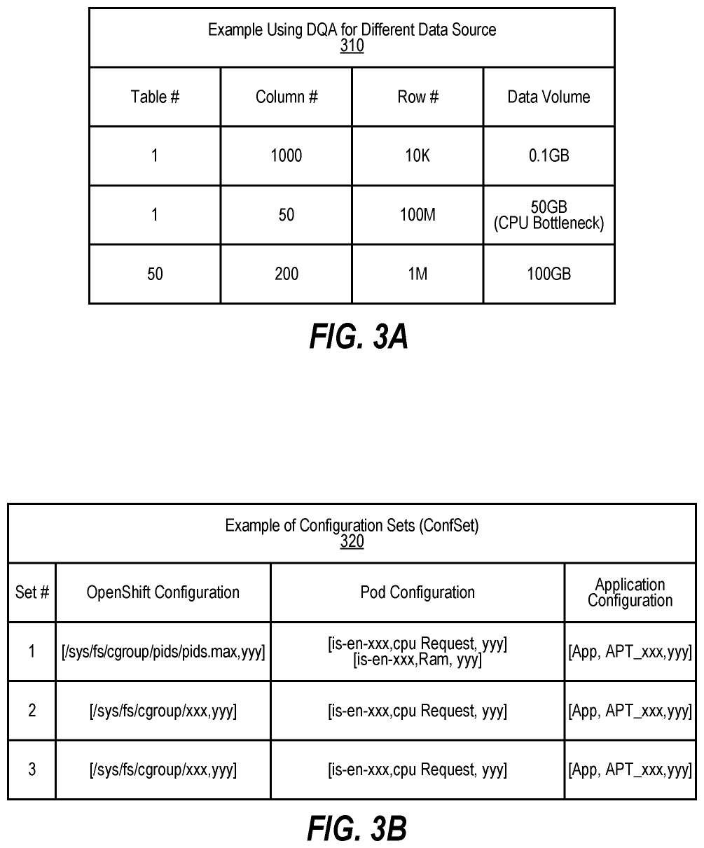

FIG. 3A is a chart depicting an example using the DQA method showing where a bottleneck occurs. Table 310 shows data for table numbers, column numbers, row numbers, and data volumes. Note that a CPU bottleneck occurs during the second row in the table due to the size of the data source being processed. The bottleneck results in poorer performance with this bottleneck being avoided by using the fingerprint matching method disclosed herein.

FIG. 3B is a chart depicting example configuration sets (ConfSet) used during fingerprint matching. Each column of table 320 shows a different configuration including OpenShift, Pod, and Application. The various sets are depicted as rows with each configuration having three sets of data. Instead of manually tuning configurations when bottlenecks are found, the present approach provides automatic matching of configuration sets based on fingerprint matching.

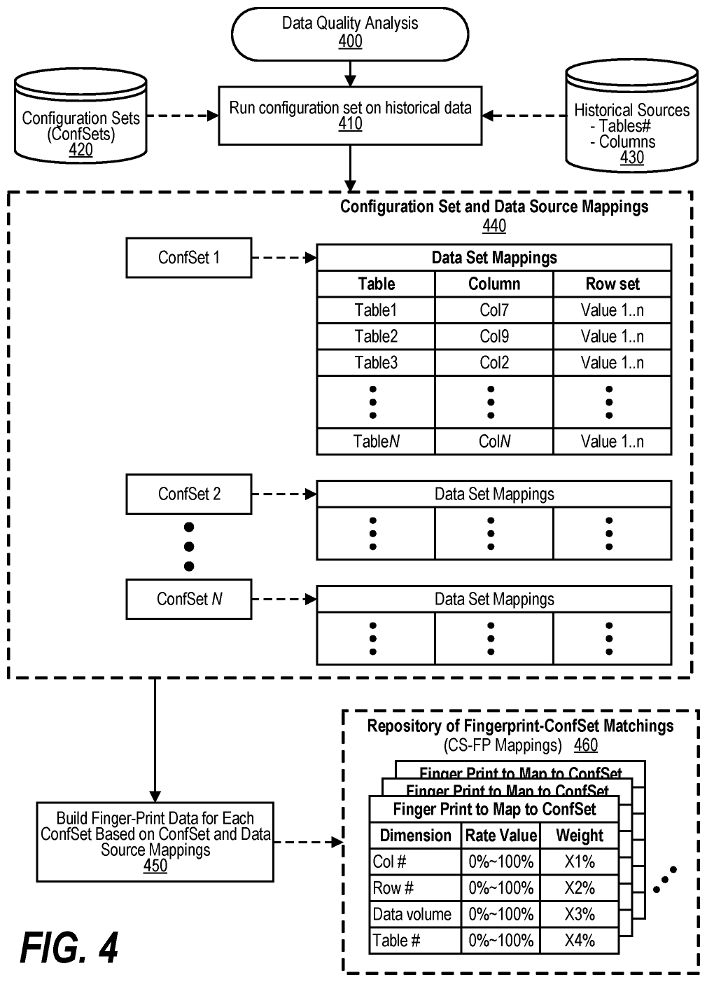

FIG. 4 is a flowchart depicting steps taken during a data quality analysis process using fingerprint matching. FIG. 4 processing commences at 400 and shows the steps taken by a process that performs Data Quality Analysis. At step 410, the process runs configuration set on historical data retrieving configuration sets (ConfSet) 420 and historical data sources (tables) from data stores 430. Step 410 results in configuration set and data source mappings shown in block 440. As shown, any number of ConfSets can be used. At step 650, the process builds Fingerprint Data for Each ConfSet Based on ConfSet and Data Source Mappings. The process builds a fingerprint for each ConfSet based on the ConfSet and the data source mapping. These resulting fingerprints are stored in repository 460.

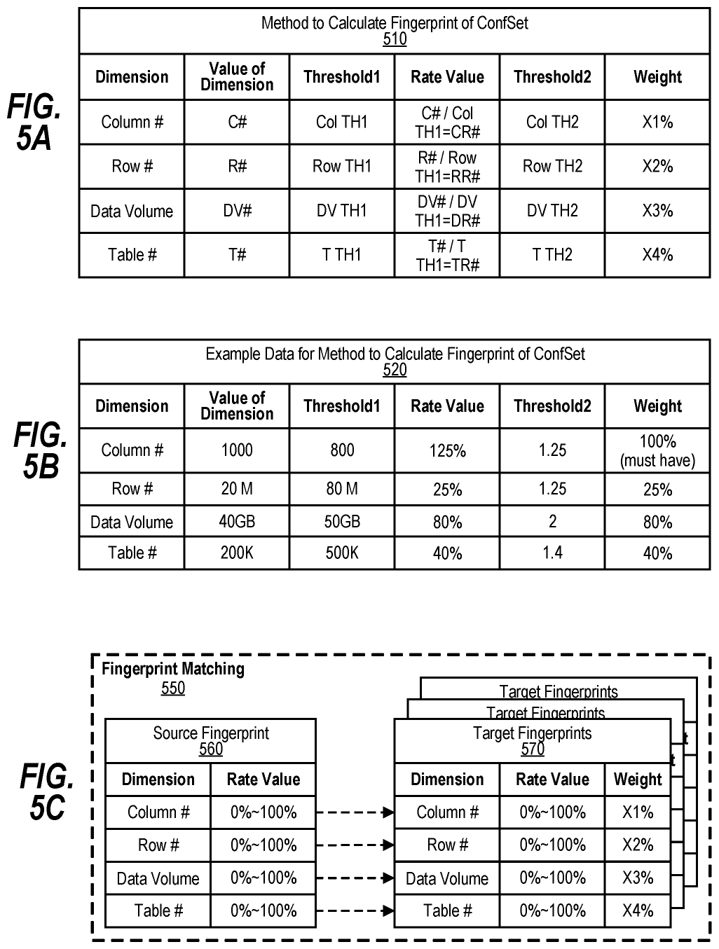

FIG. 5A is a chart depicting various dimensions and attributes to calculate fingerprints using a ConfSet. Table 510 depicts the dimension (column, row, data volume, table) and the attributes for each dimension. The resulting fingerprint of this ConfSet is the combined Rate Value (CR #, RR #, DR #, TR #, etc.).

FIG. 5B is a chart depicting sample data for the various dimensions and attributes to calculate fingerprints using a ConfSet. Table 520 depicts example data that is used to generate a fingerprint for a particular data source (table) using the dimensions and attributes introduced in FIG. 5A. Here, the resulting fingerprint of the ConfSet for this data source is (125%, 25%, 80%, 40%, etc.).

FIG. 5C is a chart depicting matching a source fingerprint with various target fingerprints. Fingerprint matching 550 matches source fingerprint 560 with target fingerprints 570. During the fingerprint matching process, the process builds leading keys according to a fingerprint dimension weight. In one embodiment, this is performed by scanning all of the fingerprint dimensions, selecting the most common dimension as the leading dimension. Keys are used (first, second or third leading keys) to build the tree. All of the fingerprint dimensions are scanned, the process selects the dimension as the leading key to build the tree based on weight being larger than a threshold. The advantage of applying fingerprint dimension weight is improvement of the fingerprint matching process.

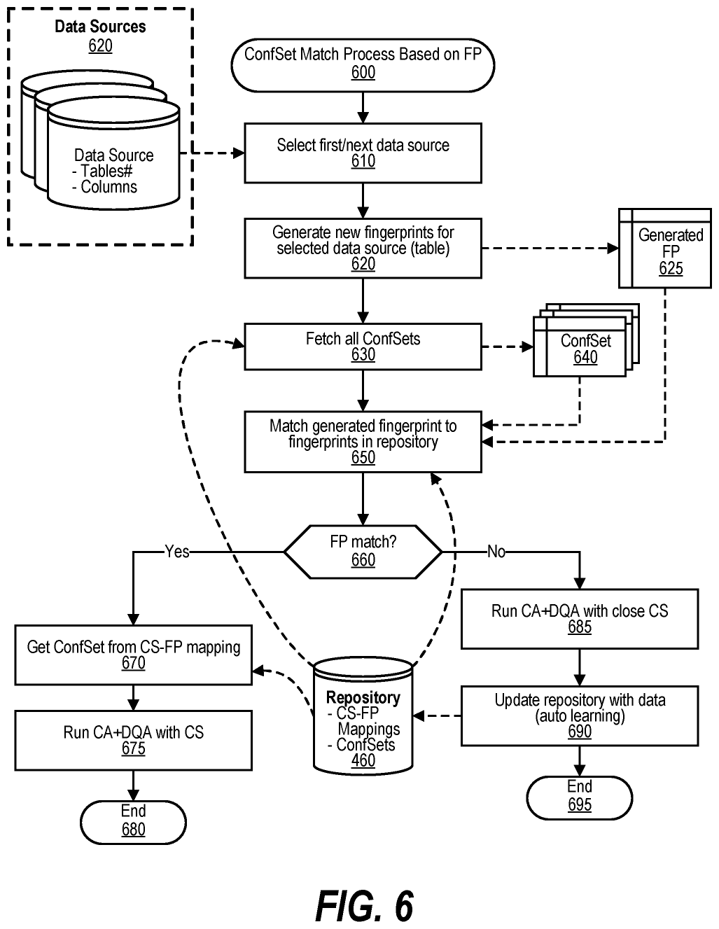

FIG. 6 is a flowchart showing a process that matches fingerprints using various attributes of an input data source (table). FIG. 6 processing commences at 600 and shows the steps taken by a process that matches a configuration set to a received data source based on the resulting fingerprint. At step 610, the process selects the first data source. At step 620, the process generates new fingerprints for selected data source (table) using one or more configuration sets and stores the generated fingerprints in memory area 625. At step 630, the process fetches the configuration sets (ConfSets) from repository 460. At step 650, the process matches the generated fingerprint, stored in memory area 625, to the fingerprints found in repository 460. The process then determines whether a generated fingerprint matches a fingerprint found in the repository (decision 660). If a fingerprint match is found, decision 660 branches to the ‘yes’ branch to perform steps 670 and 675. On the other hand, if a fingerprint match was not found, then decision 660 branches to the ‘no’ branch to perform steps 685 and 690.

When a fingerprint match is found, steps 670 and 675 are performed. At step 670, the process retrieves the configuration set from the Configuration Set-Fingerprint (CS-FP) mapping that is stored in repository 460. At step 675, the process runs the data quality analysis (CA+DQA) with the configuration set that was retrieved from the repository. FIG. 6 processing thereafter ends at 680.

When a fingerprint match is not found, steps 680 and 690 are performed. At step 685, the process runs the data quality analysis (CA+DQA) with a close configuration set (CS). At step 690, the process updates repository 460 with data (auto learning) resulting from step 680, with this data including the resulting fingerprint from using the configuration set as well as the configuration set data. Now, if the process is repeated for the same data source, a fingerprint match will be found due to the updated information stored in the repository. FIG. 6 processing thereafter ends at 695.

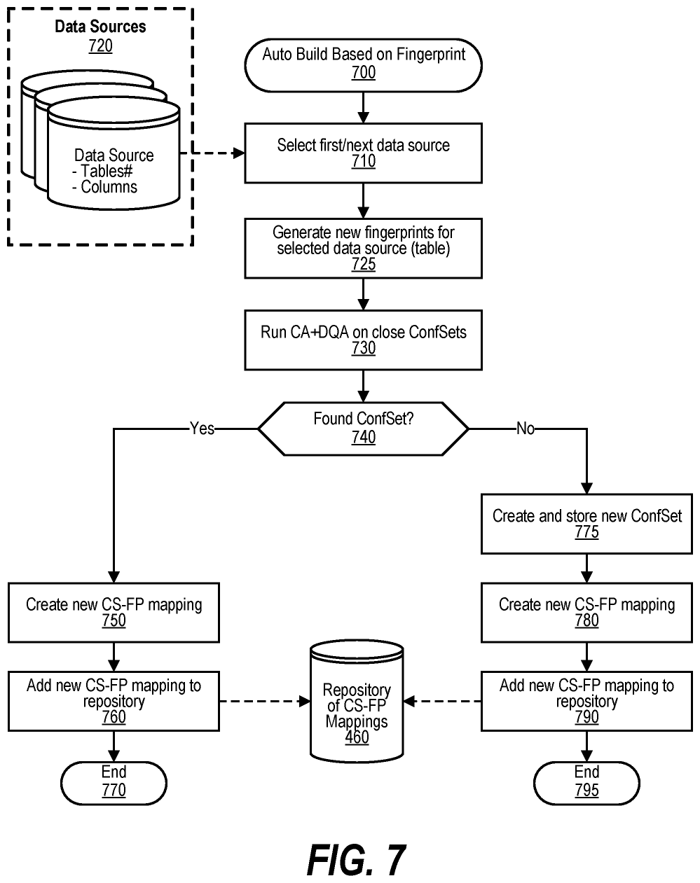

FIG. 7 is a flowchart of an auto build process that is based on generation and matching of fingerprints. FIG. 7 processing commences at 700 and shows the steps taken by a process that auto builds repository data based on fingerprint data. At step 710, the process selects the first data source from data sources 720. At step 725, the process generates new fingerprints for selected data source (e.g., a table, etc.) using one or more configuration sets. At step 730, the process runs the data quality analysis routine (CA+DQA) using close configuration sets.

The process determines as to whether a configuration set is found that corresponds to the selected data source (decision 740). If a configuration set is found that corresponds to the selected data source, then decision 740 branches to the ‘yes’ branch to perform steps 750 and 760. On the other hand, if a configuration set is not found that corresponds to the selected data source, then decision 740 branches to the ‘no’ branch to perform steps 775 through 790.

Steps 750 and 760 are performed when a configuration set is found that corresponds to the selected data source. At step 750, the process creates a new Configuration Set-Fingerprint (CS-FP) mapping. At step 760, the process adds the new CS-FP mapping data to repository 460. FIG. 7 processing thereafter ends at 770.

Steps 775 through 790 are performed when a configuration set is not found that corresponds to the selected data source. At step 775, the process creates and stores a new configuration set (ConfSet). At step 780, the process creates a new CS-FP mapping using the new configuration set. At step 790, the process adds the new CS-FP mapping to repository 460. FIG. 7 processing thereafter ends at 795.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While particular embodiments have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A computer-implemented method, implemented by an information handling system that includes a processor and a memory, the method comprising:
receiving a data source;
retrieving one or more fingerprint configuration sets corresponding to the received data source;
generating one or more data source fingerprints corresponding to the data source based on a set of fingerprint attributes included in the fingerprint configuration sets;
comparing the generated data source fingerprints to a plurality of stored fingerprints in a repository;
in response to the comparing identifying a match:
retrieving a data quality configuration set from the repository; and
performing a data quality analysis on the received data source using the retrieved data quality configuration set; and
in response to the comparing not identifying a match:
performing the data quality analysis on the received data source using a selected one of the fingerprint configuration sets; and
updating the repository with the selected fingerprint configuration set as the data quality configuration set corresponding to the received data source.

2. The method of claim 1 further comprising:
applying each of the fingerprint attributes to one or more characteristics of the received data source, the applying resulting in a fingerprint component value corresponding to each of the fingerprint attributes.

3. The method of claim 2 further comprising:
retrieving a weighting value corresponding to one or more fingerprint attributes included in the fingerprint configuration sets; and
adjusting the values corresponding to each of the fingerprint attributes by the retrieved weighting values corresponding to the fingerprint attributes.

4. The method of claim 1 further comprising:
identifying one or more close fingerprint configuration sets based on one or more characteristics of the received data source, wherein the identified fingerprint configuration sets are the retrieved fingerprint configuration sets; and
performing the data quality analysis using each of the retrieved fingerprint configuration sets.

5. The method of claim 4 further comprising:
based on the performance of the data quality analysis, selecting one of the close fingerprint configuration set as a matching fingerprint configuration set corresponding to the received data source;
generating a plurality of configuration set fingerprint mappings based on processing the received data source with the matching fingerprint configuration set; and
adding the plurality of configuration set fingerprint mappings to the repository.

6. The method of claim 4 further comprising:
based on the performance of the data quality analysis, determining that none of the close fingerprint configuration sets matches the received data source; and responsively:
creating a new configuration set corresponding to the received data source;
generating a plurality of configuration set fingerprint mappings based on processing the received data source with the new configuration set; and
adding the plurality of configuration set fingerprint mappings to the repository.

7. The method of claim 1 wherein at least one of the fingerprint attributes selected from the fingerprint configuration sets is selected from the group consisting of a number of columns, a number of rows, a data volume, a number of tables, a value contained in a particular cell, a value contained in a particular column, a value contained in a particular row, and a value of one or more tables.

8. An information handling system comprising:
one or more processors;
a memory coupled to at least one of the processors;
a set of computer program instructions stored in the memory and executed by at least one of the processors in order to perform actions comprising:
receiving a data source;
retrieving one or more fingerprint configuration sets corresponding to the received data source;
generating one or more data source fingerprints corresponding to the data source based on a set of fingerprint attributes included in the fingerprint configuration sets;
comparing the generated data source fingerprints to a plurality of stored fingerprints in a repository;
in response to the comparing identifying a match:
retrieving a data quality configuration set from the repository; and
performing a data quality analysis on the received data source using the retrieved data quality configuration set; and
in response to the comparing not identifying a match:
performing the data quality analysis on the received data source using a selected one of the fingerprint configuration sets; and
updating the repository with the selected fingerprint configuration set as the data quality configuration set corresponding to the received data source.

9. The information handling system of claim 8 wherein the actions further comprise:
applying each of the fingerprint attributes to one or more characteristics of the received data source, the applying resulting in a fingerprint component value corresponding to each of the fingerprint attributes.

10. The information handling system of claim 9 wherein the actions further comprise:
retrieving a weighting value corresponding to one or more fingerprint attributes included in the fingerprint configuration sets; and
adjusting the values corresponding to each of the fingerprint attributes by the retrieved weighting values corresponding to the fingerprint attributes.

11. The information handling system of claim 8 wherein the actions further comprise:
identifying one or more close fingerprint configuration sets based on one or more characteristics of the received data source, wherein the identified fingerprint configuration sets are the retrieved fingerprint configuration sets; and
performing the data quality analysis using each of the retrieved fingerprint configuration sets.

12. The information handling system of claim 11 wherein the actions further comprise:
based on the performance of the data quality analysis, selecting one of the close fingerprint configuration set as a matching fingerprint configuration set corresponding to the received data source;
generating a plurality of configuration set fingerprint mappings based on processing the received data source with the matching fingerprint configuration set; and
adding the plurality of configuration set fingerprint mappings to the repository.

13. The information handling system of claim 11 wherein the actions further comprise:
based on the performance of the data quality analysis, determining that none of the close fingerprint configuration sets matches the received data source; and responsively:
creating a new configuration set corresponding to the received data source;
generating a plurality of configuration set fingerprint mappings based on processing the received data source with the new configuration set; and
adding the plurality of configuration set fingerprint mappings to the repository.

14. The information handling system of claim 8 wherein at least one of the fingerprint attributes selected from the fingerprint configuration sets is selected from the group consisting of a number of columns, a number of rows, a data volume, a number of tables, a value contained in a particular cell, a value contained in a particular column, a value contained in a particular row, and a value of one or more tables.

15. A computer program product stored in a computer readable storage medium, comprising computer program code that, when executed by an information handling system, performs actions comprising:
receiving a data source;
retrieving one or more fingerprint configuration sets corresponding to the received data source;
generating one or more data source fingerprints corresponding to the data source based on a set of fingerprint attributes included in the fingerprint configuration sets;
comparing the generated data source fingerprints to a plurality of stored fingerprints in a repository;
in response to the comparing identifying a match:
retrieving a data quality configuration set from the repository; and
performing a data quality analysis on the received data source using the retrieved data quality configuration set; and
in response to the comparing not identifying a match:
performing the data quality analysis on the received data source using a selected one of the fingerprint configuration sets; and
updating the repository with the selected fingerprint configuration set as the data quality configuration set corresponding to the received data source.

16. The computer program product of claim 15 wherein the actions further comprise:
applying each of the fingerprint attributes to one or more characteristics of the received data source, the applying resulting in a fingerprint component value corresponding to each of the fingerprint attributes.

17. The computer program product of claim 16 wherein the actions further comprise:
retrieving a weighting value corresponding to one or more fingerprint attributes included in the fingerprint configuration sets; and
adjusting the values corresponding to each of the fingerprint attributes by the retrieved weighting values corresponding to the fingerprint attributes.

18. The computer program product of claim 15 wherein the actions further comprise:
identifying one or more close fingerprint configuration sets based on one or more characteristics of the received data source, wherein the identified fingerprint configuration sets are the retrieved fingerprint configuration sets; and
performing the data quality analysis using each of the retrieved fingerprint configuration sets.

19. The computer program product of claim 18 wherein the actions further comprise:
based on the performance of the data quality analysis, selecting one of the close fingerprint configuration set as a matching fingerprint configuration set corresponding to the received data source;
generating a plurality of configuration set fingerprint mappings based on processing the received data source with the matching fingerprint configuration set; and
adding the plurality of configuration set fingerprint mappings to the repository.

20. The computer program product of claim 18 wherein the actions further comprise:
based on the performance of the data quality analysis, determining that none of the close fingerprint configuration sets matches the received data source; and responsively:
creating a new configuration set corresponding to the received data source;
generating a plurality of configuration set fingerprint mappings based on processing the received data source with the new configuration set; and
adding the plurality of configuration set fingerprint mappings to the repository.
